(19) United States
(12) Patent Application Publication
(10) Pub. No.: US 2012/0289873 A1
(43) Pub. Date: Nov. 15, 2012

(54) METHOD FOR CONTROLLING MASSAGE APPARATUS AND MASSAGE APPARATUS

(75) Inventors: Xuejun Ma, Luohu Shenzhen (CN); Longshan Hu, Luohu Shenzhen (CN)

(73) Assignee: SHENZHEN BREO TECHNOLOGY CO., LTD., Luohu Shenzhen, Guangdong (CN)

(21) Appl. No.: 13/520,566

(22) PCT Filed: Jan. 31, 2011
(86) PCT No.: PCT/CN2011/070866

§ 371 Date: Jul. 4, 2012

(30) Foreign Application Priority Data
Nov. 26, 2010 (CN) 201010561016.1

(51) Int. Cl. A61H 1/00

(52) U.S. Cl. 601/18; 601/46

(57) ABSTRACT

A method for controlling massage apparatus and a massage apparatus are provided. The method includes presetting multiple temperature modes of infrared hot compress and a number of pulses corresponding to the multiple temperature modes; receiving the temperature mode (S21) selected by a user; outputting a pulse corresponding to the selected temperature mode to make the infrared hot compress operate in the temperature mode (S21) corresponding to the pulse. The temperature of the infrared hot compress may be regulated by this method.

### TECHNICAL FIELD

The present invention relates to health care field, and more particularly, to a method for controlling massage apparatus and a massage apparatus.

### BACKGROUND

With the progress of human society and development of technology, intelligent control equipments are gradually entering into the traditional technical field, e.g. the Chinese medicine moxibustion can be carried out by a massage apparatus. At the present time the massage apparatus for carrying out the Chinese medicine moxibustion produces a fixed pulse by means of the CPU of the massage apparatus to keep a certain temperature by the infrared hot compress, and the traditional Chinese medicine moxibustion may be carried out by acupoint stimulation at that temperature.

It is found that there is a shortcoming existing in the technical solution of the prior art as follows:

the temperature of the infrared hot compress is nonvariant and cannot be regulated because the pulse produced by the CPU in the method for controlling the massage apparatus in prior art is fixed.

### SUMMARY

A main object of the embodiments according to the present invention is to provide a method for controlling massage apparatus, and to provide a solution to the problem in prior art that the temperature of infrared hot compress cannot be regulated as a result of the temperature of infrared hot compress being controlled by a fixed pulse.

Another object of the present invention is to provide a massage apparatus.

A technical problem solved by the present invention is to provide a method for controlling massage apparatus, which includes:

presetting multiple temperature modes of infrared hot compress and a number of pulses corresponding to the multiple temperature modes;

receiving the temperature mode selected by a user;

outputting a pulse corresponding to the selected temperature mode to make the infrared hot compress operate in the temperature mode corresponding to the pulse.

A massage apparatus is provided in the present invention, which includes:

a storage unit for storing multiple preset temperature modes of infrared hot compress and a number of pulses corresponding to the preset temperature modes;

a mode receiving unit for receiving the mode selected by a user;

a matching output unit for outputting a pulse corresponding to the temperature mode selected by the user to make the infrared hot compress operate in the temperature mode corresponding to the pulse.

Comparing with the prior art, the advantages of the embodiments of the present invention are that there are multiple temperature modes set in the technical solution of the present invention, and the temperature of infrared hot compress may be regulated by a pulse corresponding to the temperature mode selected by a user, wherein the pulse is ouput according to the selected temperature mode, thus the present technical solution has the advantage that the temperature of the infrared hot compress can be regulated.

### BRIEF DESCRIPTION OF THE DRAWINGS

FIG. 1 is a structure view of a massage apparatus provided in Example 1 of the present invention, wherein the massage apparatus and the controller are connected by means of wireless connection;

FIG. 2 is a flow chart of a method for controlling massage apparatus in accordance with Example 1 of the present invention;

FIG. 3 is a structure view of a massage apparatus provided in Example 2 of the present invention.

### DETAILED DESCRIPTION OF THE PREFERRED EMBODIMENTS

Objects, advantages and embodiments of the present invention will be explained below in detail with reference to the accompanying drawings and Examples. However, it should be appreciated that the following description of the examples is merely exemplary in nature and is not intended to limit the present invention.

### EXAMPLE 1

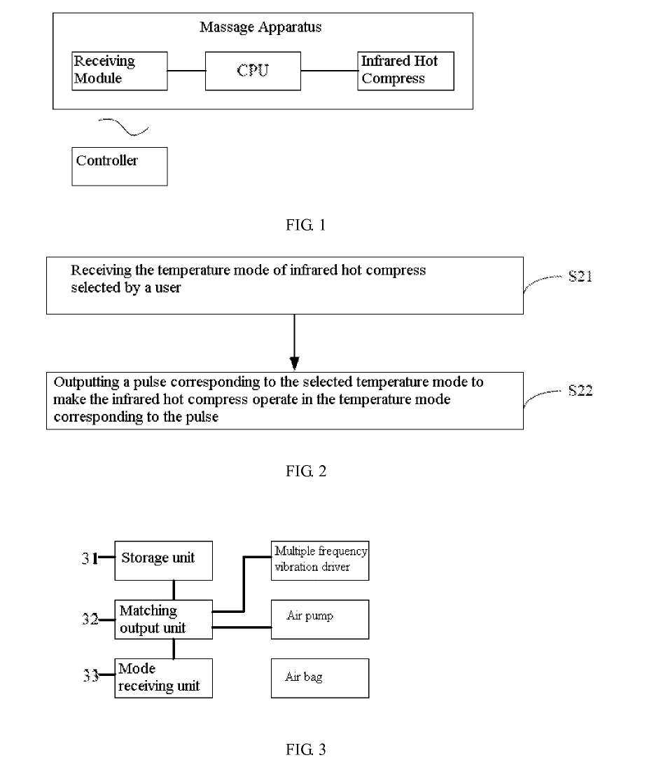

A method for controlling massage apparatus is provided in this Example, which is carried out by the massage apparatus in FIG. 1, and there are a number of pulses corresponding to multiple temperature modes (such as high temperature, moderate temperature and low temperature) of infrared hot compress preset in the massage apparatus. As shown in FIG. 2, the method includes:

S21. receiving the temperature mode of infrared hot compress selected by a user;

S22. outputting a pulse corresponding to the selected temperature mode to make the infrared hot compress operate in the temperature mode corresponding to the pulse.

Optionally, the method may include the step below after the step of S22:

detecting the response data of the user, and then adjusting the duty ratio and/or period of the pulse corresponding to the temperature mode based on the response data.

It should be noted that, the response data of the user may be: the blood pressure of the user at that moment, the movement strength of the user and the like. The principle of adjusting pulse by detecting the response data of the user so as to control the temperature of infrared hot compress is: in the massage field, the response data of a user will be in a proper range when the user feels the temperature of the apparatus is appropriate. Take blood pressure for example, usually the normal blood pressure of a user is 120/80 mmHg, and the blood pressure of the user should be in the range of normal blood pressure (e.g. the ranges of 115-125/75-85 mmHg, which certainly can be other given ranges) when the temperature of the infrared hot compress is appropriate; whereas the blood pressure of the user should be out of the normal blood pressure and the user will feel nervous when the temperature of infrared hot compress is overhigh, so the temperature of the infrared hot compress should be adjusted, i.e. lower the duty ratio and/or shorten the period of the pulse corresponding to the temperature mode to achieve the goal of adjusting the temperature of infrared hot compress (either adjusting the duty ratio or adjusting the period of the pulse may accomplish the goal of adjusting the temperature, so both of them may be selected), as a result the temperature of infrared hot compress may be adjusted automatically in the mode of temperature basing on the response(i.e. response data) of a user in this method, and an appropriate temperature of infrared hot compress can be provided to the user.

It should be noted that, the detail of adjusting the duty ratio and/or the period of the pulse corresponding to the temperature mode basing on the response data may be as follows: lower the duty ratio and/or shorten the period of the pulse corresponding to the temperature mode when the response data surpasses the given range; and increase the duty ratio and/or lengthen the period of the pulse corresponding to the temperature mode when the response data is below the given range.

Optionally, the massage apparatus of the present method further includes a multiple frequency vibration driver, and the method may further include before S11 or after S12: presetting a number of pulses corresponding to multiple vibration modes (such as strong, moderate and weak) of the multiple frequency vibration driver;

receiving the vibration mode selected by a user, and outputting a pulse corresponding to the selected vibration mode to the multiple frequency vibration drivers.

It should be noted that, the strength of vibration may be adjusted based on the response data of a user in the vibration mode selected by the user.

Optionally, the massage apparatus in the above-mentioned method may further include: an air pump and an air bag connected thereto, wherein the air pump controls the pressure of the air bag, and the method may further include before S11 or after S12: presetting a number of pulses corresponding to multiple working modes of the air bag;

receiving the working mode of the air bag selected by a user, and outputting a pulse corresponding to the selected working mode of the air bag to the air pump.

It should be noted that, the process of receiving the working mode (including the mode of temperature, the working mode of air bag and the mode of vibration) selected by a user may be carried out via a wired or wireless means, the detail of the embodiment may be as follows: when a wired means is employed, there may be a controller with all of the working modes equipped on the massage apparatus; when a wireless means is employed, there may be a wireless receiver with all of the working modes equipped on the massage apparatus, and the wireless means may be a short distance transmission, e.g. infrared, Bluetooth and the like.

The method provided in the embodiment of the present invention achieves the goal of adjusting the temperature of infrared hot compress by presetting a number of pulses corresponding to multiple temperature modes, then outputting a pulse corresponding to the selected temperature mode according to the temperature mode selected by the user, and in this method the temperature of infrared hot compress may be adjusted according to the data of the user's response to the infrared hot compress automatically, thus it has the advantage of adjusting the temperature of infrared hot compress basing on the response data of the user. The method further provides multiple vibration modes and multiple working modes of air bag for the user to choose.

### EXAMPLE 2

A massage apparatus is provided in this Example, which is shown in FIG. 3, including:

a storage unit 31 for storing preset multiple temperature modes of infrared hot compress and a number of pulses corresponding to the multiple temperature modes;

a mode receiving unit 32 for receiving the mode selected by a user;

a matching output unit 33 for outputting a pulse corresponding to the selected temperature mode to make the infrared hot compress operate in the temperature mode corresponding to the pulse.

Optionally, the apparatus above-mentioned further includes a multiple frequency vibration driver, and the storage unit 31 further stores a number of pulses corresponding to preset multiple vibration modes of the multiple vibration driver, the mode receiving unit 32 further receives the vibration mode selected by the user; the matching output unit 33 further outputs a pulse corresponding to the vibration mode to the multiple vibration driver.

Optionally, the apparatus above-mentioned further includes an air pump and an air bag connected thereto, and the storage unit 31 further stores a number of pulses corresponding to preset multiple working modes of the air bag; the mode receiving unit 32 further receives the working mode of the air bag selected by the user; the matching output unit 33 further outputs a pulse corresponding to the working mode of the air bag to the air pump.

Optionally, the apparatus above-mentioned further includes a music player such as MP3 or the like.

Optionally, the apparatus above-mentioned is arranged in a head massage device, a foot massage device or an eye massage device.

The massage apparatus according to the embodiment of the present invention achieves the goal of adjusting the temperature of the infrared hot compress by presetting a number of pulses corresponding to multiple temperature modes, then outputting a pulse corresponding to the temperature mode according to the temperature mode selected by the user, so as to adjust the temperature of the infrared hot compress.

It should be noted that, each unit of the system above-mentioned is only partitioned by the function logic and the partition is not limited by the function logic, there may be other ways of partition if only the corresponding function can be carried out; on the other hand the special name of each unit is only to distinguish one from the other, but not to limit the scope of the present invention.

On the other hand, it should be appreciated by one skilled in the art that all of the steps or part of the steps in the method of Examples of the invention can be carried out by correlative hardware instructed by a program, which may be stored in a computer readable storage media such as ROM, disk, CD and the like.

The embodiments above are merely the preferable embodiments of the present invention and not intended to limit the present invention. And all changes, equivalent substitution and improvements which come within the meaning and range of equivalency of the present invention are intended to be embraced therein.

What is claimed is:

1. A method for controlling massage apparatus comprising:
presetting multiple temperature modes of infrared hot compress and a number of pulses corresponding to the multiple temperature modes;
receiving the temperature mode selected by a user;
outputting a pulse corresponding to the selected temperature mode to make the infrared hot compress operate in the temperature mode corresponding to the pulse.

2. The method of claim 1, wherein the said massage apparatus further comprises:
a multiple frequency vibration driver, and the said method further comprises:
presetting a number of pulses corresponding to multiple vibration modes of the multiple frequency vibration driver;
receiving the vibration mode selected by a user, and outputting a pulse corresponding to the selected vibration mode to the multiple frequency vibration driver.

3. The method of claim 1, wherein the said massage apparatus further comprises:
an air pump and an air bag connected thereto, and the method further comprises:
presetting a number of pulses corresponding to multiple working modes of the air bag;
receiving the working mode of the air bag selected by a user, and outputting a pulse corresponding to the selected working mode of the air bag to the air pump.

4. The method of claim 1, wherein the process of the receiving the temperature mode selected by a user comprises:
receiving the temperature mode selected by a user via a wired or wireless means.

5. A massage apparatus comprising:
a storage unit for storing multiple preset temperature modes of infrared hot compress and a number of pulses corresponding to the preset temperature modes;
a mode receiving unit for receiving the mode selected by a user;
a matching output unit for outputting a pulse corresponding to the selected temperature mode to make the infrared hot compress operate in the temperature mode corresponding to the pulse.

6. The massage apparatus of claim 5, wherein the massage apparatus further comprises a multiple frequency vibration driver, the storage unit is further used for storing a number of pulses corresponding to preset multiple vibration modes of the multiple frequency vibration driver; the mode receiving unit is further used for receiving the vibration mode selected by a user; and the matching output unit is further used for outputting a pulse corresponding to the vibration mode to the multiple frequency vibration driver.

7. The massage apparatus of claim 5, wherein the massage apparatus further comprises: an air pump and an air bag connected thereto, and the storage unit is further used for storing a number of pulses corresponding to preset multiple working modes of the air bag; the mode receiving unit is further used for receiving the working mode of the air bag selected by the user; the matching output unit is further used for outputting a pulse corresponding to the working mode of the air bag to the air pump.

8. The massage apparatus of claim 5, wherein the massage apparatus further comprises a music player.

9. The massage apparatus of claim 5, wherein the massage apparatus is arranged in a head massage device, a foot massage device or an eye massage device.
